(19) United States
(12) Patent Application Publication
(10) Pub. No.: US 2008/0236691 A1
(43) Pub. Date: Oct. 2, 2008

(54) Lift hole plug

(76) Inventor: Larry D. Roll, Horicon, WI (US)

Correspondence Address: Laura A. Dable;RYAN KROMHOLZ & MANION, S.C., Post Office Box 26618, Milwaukee, WI, 53226-0618, US

(21) Appl. No.: 12/079,981

(22) Filed: Mar. 31, 2008

Related U.S. Application Data
(60) Provisional application No. 60/921,393, filed on Apr. 2, 2007.

(51) Int. Cl. F16L 55/10

(52) U.S. Cl. 138/92; 138/89

(57) ABSTRACT

A removable plug adapted to seal lifting holes in tubular conduits. The plug includes a cap member having top surface and a bottom surface, the top surface having a cavity therein to facilitate removal, the bottom surface having and a longitudinally extending shaft portion wherein radially extending fins form a generally cruciform cross section.

### RELATED APPLICATIONS

This application claims the benefit of U.S. provisional patent application Ser. No. 60/921,393 filed 2 Apr. 2007.

### BACKGROUND OF THE INVENTION

The present invention relates to plugs used to close openings in concrete pipes and other large tubular conduit structures. Specifically, the plug of the present invention is to be used to close lift holes in such structures.

Concrete pipes and other large conduit structures used as drain pipe and the like, are typically transported in sections. The sections are then lifted from the transport means and placed in an operational location, such as a trench for example, where final assembly of multiple section lengths is done. Individual heavy sections are lifted from the transport means by way of conventional lifting means, such as a crane. The lifting means typically includes a cable or chain that passes through lift holes in the conduit wall. The lift holes further facilitate positioning during coupling of individual conduit sections, with lifting means engaging the lifting holes.

After the conduit is properly positioned in its operational condition, it is necessary to fill the lifting holes to thereby prevent dirt, debris and the like from entering the structure.

Presently, workers plug the holes with rocks and mortar. This procedure is inefficient and time-consuming, since the worker must spend time searching for suitably sized rocks and debris to fill the hole and must further wait for the mortar to set. In addition, a patch formed in this manner is often dislodged by certain environmental forces such as moisture, resulting in further problems requiring re-excavation.

An alternative known means of filling lifting holes is by way of a stopper device marketed under the POPIT trademark and described in U.S. Pat. Nos. 6,360,779, D456,880, and D458,350. Although the POPIT device solves some of the problems associated with rock and mortar patching, certain inefficiencies persist. Specifically, the particular arrangement of the POPIT device causes difficulty should removal of the device be necessary. For example, the POPIT device includes a cap member with a stem projecting from the cap member; the stem member further includes radially extending web means for anchoring the device to the lifting hole. During removal, the web means is prone to catch on the inner wire mesh structure of a concrete conduit, and in some instances, may necessitate a worker to crawl inside the conduit to force removal. A POPIT device removed in this manner is usually damaged and unable to be reused.

The present invention contemplates an improvement of stopper-type devices, by providing a device that is both easy to put in place and, if necessary, to remove.

### SUMMARY OF THE INVENTION

The present invention provides a simple and low cost plug for filling the lift holes in tubular conduits prior to covering the worksite, such as a trench, with earth or other back fill. The invention accomplishes this purpose by providing a stopper device or plug having a cap member in the form of a substantially planar disc, preferably made of plastic, and provided with a stem member laterally extending endwise from one side of the cap member. The stem member preferably has a generally cruciform cross section formed by a plurality of laterally extending fin members. The cap member further preferably includes a releasably attachable access cavity to facilitate removal.

The particular arrangement of the present stem member allows for secure friction fit, but also allows the device facile removal and reuse, if required. The size of the device may be adapted for use with variously sized lift holes, without departing from the spirit of the invention.

The invention generally includes a cap member and a stem member. The cap member preferably includes a top side and a bottom side, with the stem member extending from the bottom side of the cap member. The stem member is preferably of a generally cruciform cross section which thereby provides at least four fins extending from a central axis. The fins are preferably disposed substantially at 90 degrees relative one another to thereby form the aforementioned cruciform cross section. Although this arrangement is preferred, it is to be understood that it is within the scope of the present invention to arrange the fins in other arrangements, including at various angles of relative placement and various total number of fins.

The present device may be composed of any durable material that is capable of being inserted in the lift hole and effectively remaining in place after construction and placement of the conduit, including plastic materials. The cap member and stem member may be integrally molded as a one-piece construction, as by injection molding.

As seen in the drawings, the cap member preferably includes means for removing the plug. The means for removing, such as a releasably attachable means, allows the user to remove the plug from the lifting hole as may be necessary from time to time. Such means may include providing the top surface of the cap member with at least one upright or upstanding rib member. The upright preferably includes an access cavity. The user may engage the access cavity to remove the plug. Alternatively, the top surface itself may provide means for removing by way of an incised cavity, which may be engaged by a tool such as a screwdriver head to lift the plug from its installed position.

### BRIEF DESCRIPTION OF THE DRAWINGS

FIG. 1 is a perspective view of an embodiment of the invention.

FIG. 2 is a front elevation view of the embodiment illustrated in FIG. 1, the back elevation view being identical thereto.

FIG. 3 is a top plan view of the embodiment illustrated in FIGS. 1 and 2, and showing an access cavity to facilitate removal.

FIG. 4 is a bottom plan view of the plug shown in FIGS. 1-3, and showing the generally cruciform cross section of the stem member.

FIG. 5 is a cross sectional view of the present invention, taken along lines 5-5 of FIG. 6, and showing the device in operational condition in a generally circular conduit lift hole, with a fragmentary view of the conduit.

FIG. 6 is a bottom view of the plug shown in FIG. 5, and illustrating deflection of the fin members while in place in a generally circular lift hole, with a fragmentary view of the conduit.

FIG. 7 is a cross sectional view of the present invention, taken along lines 7-7 of FIG. 8, and showing the device in operational condition in a lift hole having an irregular diameter with a fragmentary view of the conduit.

FIG. 8 is a bottom view of the plug shown in FIG. 7, and illustrating deflection of the fin members while in place in an irregularly configured lift hole, with a fragmentary view of the conduit

FIG. 9 is a view of a tubular conduit having lifting holes therein of the type to be fitted with the plug of the present invention.

FIG. 10A is a perspective view of an alternative plug and showing a cap member with incised cavity.

FIG. 10B is a fragmentary cross sectional view of the embodiment shown in FIG. 10A and taken along lines 10B-10B thereof.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

As mentioned above, typical poured concrete conduit, or other tubular conduit is conventionally made in predetermined lengths as dictated by ultimate use and transportation limitations. The conduit is transported by conventional means, such as flat bed truck to an installation site where the individual conduit lengths are assembled, end to end, for their predetermined purpose.

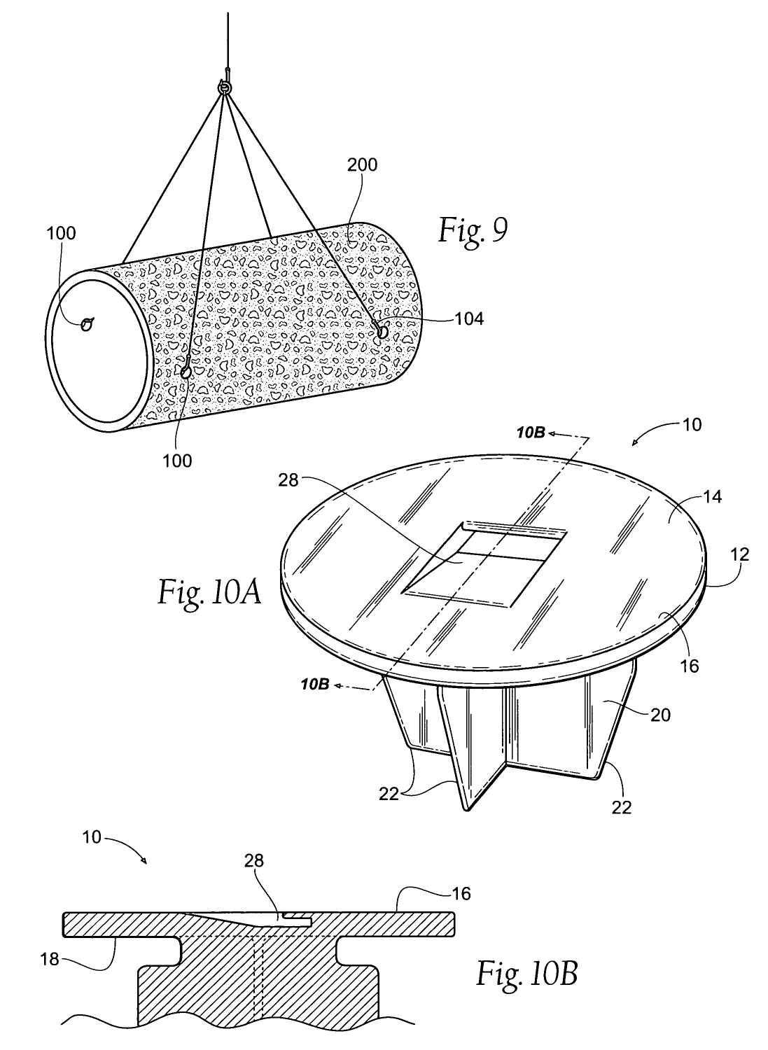

As illustrated in FIG. 9, since the individual conduit lengths 200 are typically heavy and unwieldy, a lift hole 100 is conventionally provided through the side wall of the conduit length 200. As seen in the view of FIG. 9, the lift hole 100 has as its purpose to provide access for lifting means, such as the lift hook(s) 104 shown. The means for lifting preferably further includes the use of a crane (not shown) or other conventional means, which is used to both move the conduit 200 from transport means, and to align the conduit 200 during installation.

If the conduit 200 is to be installed in a trench or other earthen environment, the lift hole 100 must be filled to prevent infiltration of moisture or other damaging material. As mentioned previously, the present conventional method of filling the lift hole includes inserting a brick or stone into the hole and covering with mortar.

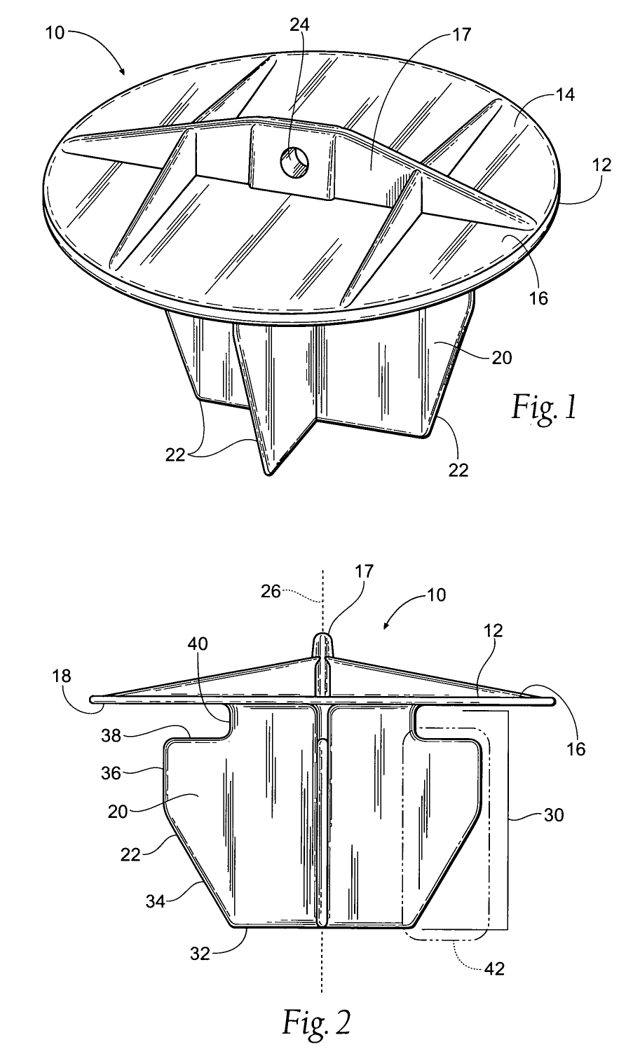

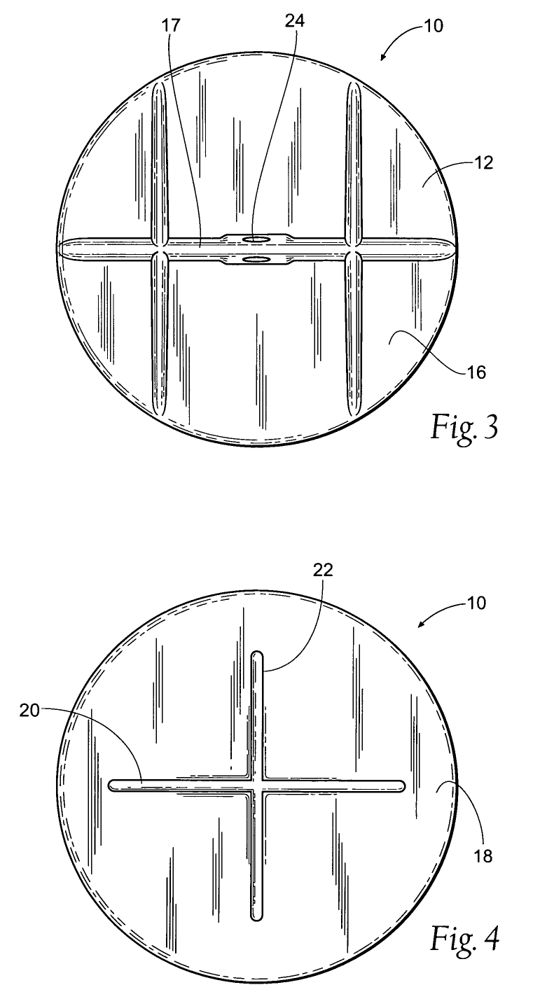

Referring now to FIGS. 1 and 2, a plug 10 according to the present invention is illustrated. The plug 10 preferably includes a cap member 12 in the form of a substantially planar disc 14 and having a top surface 16 and an opposed bottom surface 18. Although illustrated as being generally circular, it is to be understood that the cap member 12 may be of any appropriate shape, such as oval. Further, the plug 10 may be modified to fit lift holes of varying sizes without departing from the spirit of the invention. As seen, a stem member 20 laterally extends endwise from the bottom surface 18 of the cap member 12. The stem member 20 preferably has a generally cruciform cross section formed by a plurality of laterally extending fin members 22. The cap member 12 and stem member 20 may be integrally molded as a one piece construction, as by injection molding.

Further referring to FIGS. 1 and 2, it may be seen that the top surface 16 of the cap member 12 preferably includes releasable attachment means, such as the access cavity 24 shown, to thereby facilitate removal of the plug from a lift hole (not seen in these views). Means for removing the plug 10 allows the user to remove the plug 10 from the lifting hole 100, as may be necessary from time to time. As observed in FIG. 1, such means may include providing the top surface 16 of the cap member 12 with at least one upstanding rib member 17. When provided with an upstanding rib member 17, the rib member preferably includes an access cavity 24. The user may then engage the access cavity 24 to remove the plug 10 as needed. Alternatively, and as viewed in FIGS. 10A and 10B, the top surface 16 may be provided with means for removing by way of an incised cavity 28, which may be engaged by a tool such as a screwdriver head (not shown) to lift the plug 10 from its installed position.

The plug 10 according to the present invention may be composed of any acceptable durable material that is capable of being inserted in a lift hole and effectively remaining in place after construction and placement of the conduit. Preferably, any injection molded plastic may be used, however the choice of material is dictated only by convenience, availability and low cost of materials.

With particular reference to FIG. 2, configuration of the stem member 20 and laterally extending fins 22 may be seen. Specifically, the fins 22 of the present invention extend laterally from the axis 26 of the stem member 20. As may be observed, each respective fin member 22 extends laterally from the stem axis 26 to form a preferred marginal edge profile 30. The preferred fin marginal edge profile 30 includes a bottom marginal edge portion 32 extending laterally from the stem member axis 26. The bottom edge portion 32 intersects with a second marginal edge portion 34 which extends angularly outwardly relative to the stem member axis 26. The second marginal edge portion 34 intersects with a third marginal edge portion 36 which is essentially parallel to the stem member axis 26. The third marginal edge portion 36 intersects with a fourth marginal edge portion 38. The fourth marginal edge portion 38 extends laterally inwardly from the third marginal edge portion 36. As seen the fourth marginal edge portion 38 preferably extends inwardly relative to the stem member axis 26. The fourth marginal edge portion 38 intersects a fifth, terminal edge portion 40 which intersects with the bottom surface 18 of the cap member 12. The specific fin profile 30 allows the plug 10 to be inserted into lift holes 100 of various dimensions, while effectively sealing the hole 100.

It may be noted that at least a portion of each fin profile 30 is flexible. For example, as seen in FIG. 2, the area noted generally as 42, which includes the second, third and fourth marginal edge portions, 34, 36, 38, respectively, is preferably relatively flexible as compared to the other elements of the stem 20 and fin profile 30. The flexibility is offered primarily due to the nature of the fin profile 30. That is, since the third and fourth marginal edge portions, 36, 38, are not directly connected to the bottom surface 18 of the cap member 12, as is the fifth marginal edge portion 40, as long as each fin member 22 is manufactured from a relatively thin, flexible material, that portion of each fin member 22 is free to bend and deflect as it comes in contact with the inside surface 102 of a lifting hole 100. The flexible portion 42 of a respective fin member 22 enables the plug 10 to be secured in a selected lift hole 100. It is to be further noted that while not shown, it is within the scope of the present invention to provide the fin members 22 with additional flexibility by tapering the thickness of any of the aforementioned marginal edge portions 32, 34, 36, 38, 40.

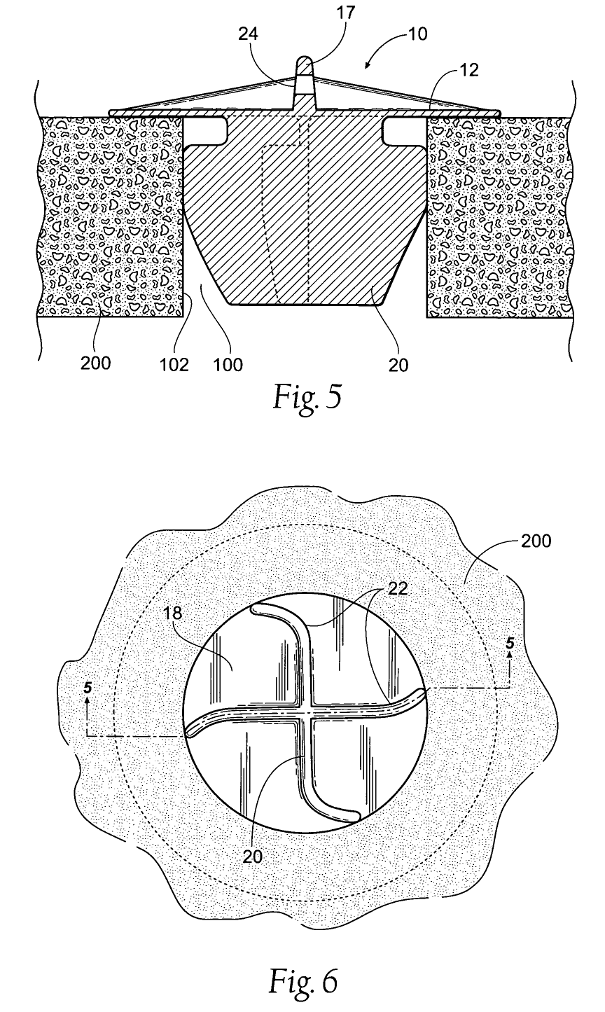

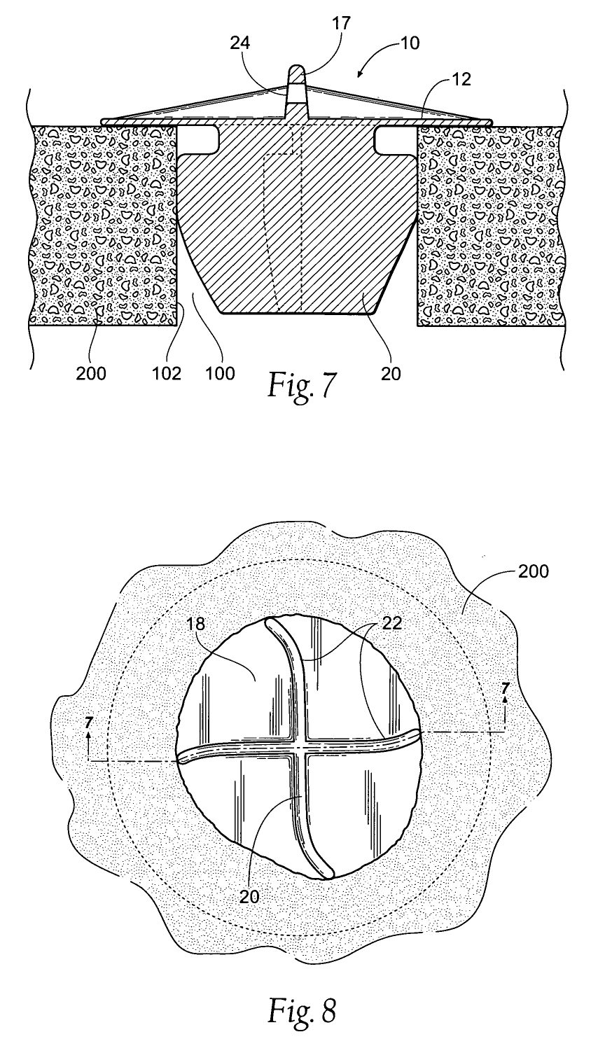

As may be observed in FIGS. 5-8, the aforementioned preferred profile 30 of the fin members 22 allows respective fin members 22 to deflect relative the stem member axis 26 to thereby adapt to a specific lift hole 100 contour. For example, and as viewed in FIGS. 5 and 6, since the fin profile 30 includes the aforementioned flexible portion 42, the fin members 20 are able to deflect to the degree needed to effectively hold the plug 10 in a lift hole 100, regardless of any dimensional variation in the contour of the inside surface 102. A comparison of FIGS. 5 and 6 with FIGS. 7 and 8 reveals that the specific fin profile 30 permits the fin members 22 to deflect in a manner appropriate for the irregularly contoured lift hole 100 illustrated- in FIGS. 7 and 8. The adaptability afforded by the specific fin profile 30 enhances the practicality of the plug 10 according to the present invention.

As mentioned previously, the stem member 20 and extending fins 22 is of a generally cruciform cross section provided by at least four fin members 22 extending from the stem member central axis 26. As best viewed in FIG. 4, the fin members 22 are preferably disposed substantially at 90 degrees relative one another to thereby form the aforementioned cruciform cross section. Although this arrangement is preferred, it is to be understood that it is within the scope of the present invention to arrange the fin members 22 in other arrangements, including various angles of relative placement and various total number of fin members 22.

The particular arrangement of the present stem member 20 allows for secure friction fit, but also allows facile removal and re-use, if required. The size of the device may be adapted for use with variously sized lift holes, without departing from the spirit of the invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A plug device for blocking a hole in a tubular conduit, said device comprising:
a substantially planar cap member, said cap member having a top surface and a bottom surface;
a stem member laterally extending endwise from said bottom surface, said stem member having an axis;
a plurality of fins members, each of said plurality of fin members laterally extending from said axis, each of said plurality of fins having a predetermined profile.

2. The plug device of claim 1 wherein said top surface of said cap member further includes releasable attachment means for withdrawing said plug from said hole.

3. The plug device of claim 1 wherein said profile includes a bottom marginal edge portion extending laterally from said axis and a second marginal edge portion, said second marginal edge portion extending angularly outwardly relative to said axis and intersecting with said bottom marginal edge portion.

4. The plug device of claim 3 wherein said profile further includes a third marginal edge portion, said third marginal edge portion intersecting said second marginal edge and being substantially parallel to said axis.

5. The plug device of claim 4 wherein said profile further includes a fourth marginal edge portion, said fourth marginal edge portion intersecting said third marginal edge portion and extending laterally inwardly from said third marginal edge portion relative to the stem member axis.

6. The plug device of claim 5 wherein said profile further includes a terminal marginal edge portion, said terminal marginal edge portion intersecting said fourth marginal edge portion and intersecting with said bottom surface of said cap member.

7. The plug device of claim 2 wherein said releasable attachment means includes an upstanding rib member having an aperture therethrough.

8. The plug device of claim 2 wherein said releasable attachment means comprises an incised portion on said top surface, said incised portion being adapted for releasable engagement with a lifting tool.

9. The plug device of claim 6 wherein said second marginal edge portion, said third marginal edge portion and said fourth marginal edge portion comprise a relatively flexible fin area.
